(19) United States
(12) Patent Application Publication
(10) Pub. No.: US 2017/0122843 A1
(43) Pub. Date: May 4, 2017

(54) STABLE MANUFACTURING EFFICIENCY GENERATING METHOD AND SYSTEM AND NON-TRANSITORY COMPUTER READABLE STORAGE MEDIUM

(71) Applicant: INSTITUTE FOR INFORMATION INDUSTRY, TAIPEI (TW)

(72) Inventors: Cheng-Juei YU, Taipei City (TW); Yin-Jing TIEN, Taipei City (TW); Ming-Cheng SHENG, Kaohsiung City (TW); Wei-Wen WU, New Taipei City (TW); Kuan-Yu LU, Taichung City (TW); Shih-Hsiang TING, Tainan City (TW); Yi-Hsin WU, Taipei City (TW); Grace LIN, Hualien County (TW)

(21) Appl. No.: 14/945,396

(22) Filed: Nov. 18, 2015

(30) Foreign Application Priority Data
Nov. 4, 2015 (TW) 104136355

(51) Int. Cl. G01M 99/00

(52) U.S. Cl. CPC G01M 99/008

(57) ABSTRACT

A stable manufacturing efficiency generating method includes the steps: generating a real-time grouping parameter set according to a plurality of historical efficiency values; grouping a plurality of real-time efficiency values corresponding to a product to generate a plurality of real-time efficiency groups according to the real-time grouping parameter set; selecting one of the real-time efficiency groups having most real-time efficiency values as a stable efficiency group; and generating a stable manufacturing efficiency value according to an average value of the real-time efficiency values in the stable efficiency group.

### RELATED APPLICATIONS

This application claims priority to Taiwanese Application Serial Number 104136355, filed Nov. 4, 2015, which is herein incorporated by reference.

### BACKGROUND

Technical Field

The present disclosure relates to a manufacturing efficiency generating method and system. More particularly, the present disclosure relates to a stable manufacturing efficiency generating method and system.

Description of Related Art

The current technology is such that all efficiency values obtained at different times are calculated to generate a stable manufacturing efficiency value of a product. However, if an abnormal event occurs at a time during a manufacturing process, the stable manufacturing efficiency value will be not accurate. Another method is to use kernel density estimation (K.D.E) method to calculate the stable manufacturing efficiency value of the product. However, all efficiency values obtained at different times are calculated if K.D.E is used for calculating the stable manufacturing efficiency value of the product, such that the calculating time and calculating burden will be enormous.

### SUMMARY

One embodiment of the present disclosure is related to a stable manufacturing efficiency generating method. The stable manufacturing efficiency generating method includes: generating a real-time grouping parameter set according to a plurality of historical efficiency values; grouping a plurality of real-time efficiency values corresponding to a product to generate a plurality of real-time efficiency groups according to the real-time grouping parameter set; selecting one of the real-time efficiency groups having most real-time efficiency values as a stable efficiency group; and generating a stable manufacturing efficiency value according to an average value of the real-time efficiency values in the stable efficiency group.

Another embodiment of the present disclosure is related to a stable manufacturing efficiency generating system. The stable manufacturing efficiency generating system includes a grouping parameter generating module and a stable efficiency generating module. The grouping parameter generating module is configured to generate a real-time grouping parameter set according to a plurality of historical efficiency values. The stable efficiency generating module is configured to group a plurality of real-time efficiency values corresponding to a product to generate a plurality of real-time efficiency groups according to the real-time grouping parameter set, select one of the real-time efficiency groups having most real-time efficiency values as a stable efficiency group and generate a stable manufacturing efficiency value according to an average value of the real-time efficiency values in the stable efficiency group.

Yet another embodiment of the present disclosure is related to a non-transitory computer readable storage medium storing a computer program. The computer program is configured to execute a stable manufacturing efficiency generating method. The stable manufacturing efficiency generating method includes: generating a real-time grouping parameter set according to a plurality of historical efficiency values; grouping a plurality of real-time efficiency values corresponding to a product to generate a plurality of real-time efficiency groups according to the real-time grouping parameter set; selecting one of the real-time efficiency groups having most real-time efficiency values as a stable efficiency group; and generating a stable manufacturing efficiency value according to an average value of the real-time efficiency values in the stable efficiency group.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram illustrating a stable manufacturing efficiency generating system according to one embodiment of the present disclosure;

FIG. 2 is a flow diagram illustrating a stable manufacturing efficiency generating method according to one embodiment of this disclosure; and

FIG. 3A-3D is a schematic diagram illustrating a calculation of a stable manufacturing efficiency value according to one embodiment of this disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. The embodiments below are described in detail with the accompanying drawings, but the examples provided are not intended to limit the scope of the disclosure covered by the description. The structure and operation are not intended to limit the execution order. Any structure regrouped by elements, which has an equal effect, is covered by the scope of the present disclosure.

Moreover, the drawings are for the purpose of illustration only, and are not in accordance with the size of the original drawing. The components in description are described with the same number to understand.

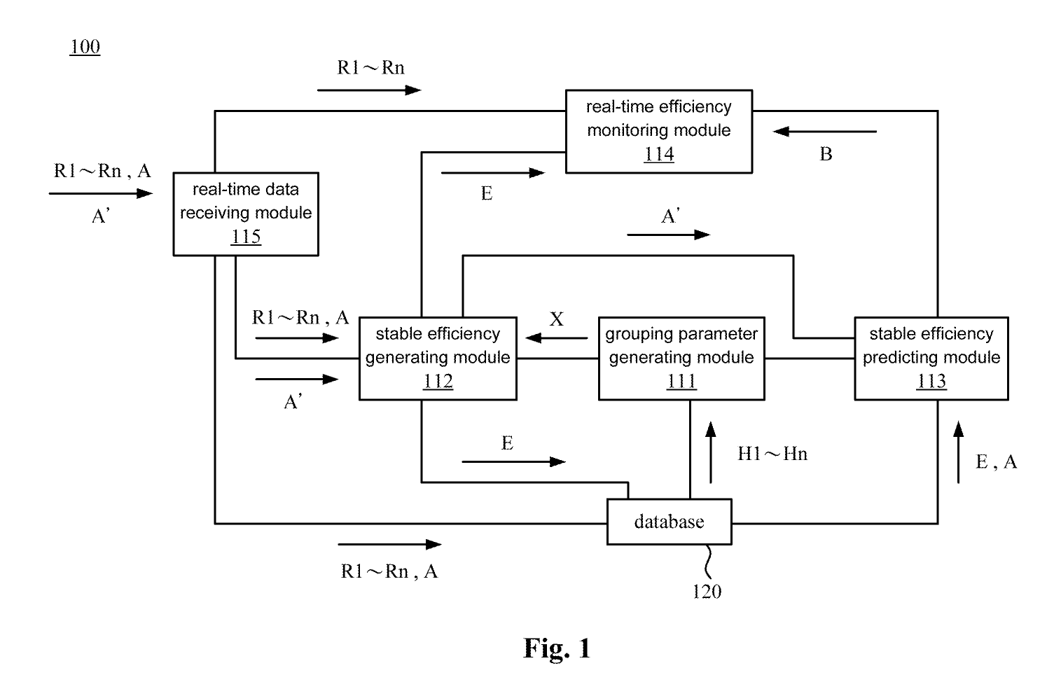

FIG. 1 is a block diagram illustrating the stable manufacturing efficiency generating system 100 according to one embodiment of the present disclosure. As illustrated in FIG. 1, in some embodiments, the stable manufacturing efficiency generating system 100 includes a grouping parameter generating module 111 and a stable efficiency generating module 112. The stable efficiency generating module 112 is coupled to the grouping parameter generating module 111. The grouping parameter generating module 111 is configured to generate a real-time grouping parameter set according to a plurality of historical efficiency values. The stable efficiency generating module 112 is configured to group a plurality of real-time efficiency values corresponding to a product to generate a plurality of real-time efficiency groups according to the real-time grouping parameter set. The stable efficiency generating module 112 is configured to select one of the real-time efficiency groups having most real-time efficiency values as a stable efficiency group. The stable efficiency generating module 112 is configured to generate a stable manufacturing efficiency value according to an average value of the real-time efficiency values in the stable efficiency group. In some embodiments, the stable efficiency generating module 112 utilizes “data binning technique” to generate the real-time grouping parameter set and to group the plurality of real-time efficiency values.

Since the stable manufacturing efficiency generating system 100 groups the plurality of real-time efficiency values according to the real-time grouping parameter set and only parts of real-time efficiency values are used for calculating the stable manufacturing efficiency value, time for calculation can be saved. Moreover, since the real-time grouping parameter set is generated according to the plurality of “historical” efficiency values, the real-time grouping parameter set extremely has reference value for grouping. Moreover, since the real-time efficiency group having most real-time efficiency values is selected as the stable efficiency group to calculate the stable manufacturing efficiency value, an abnormal efficiency value will not be contained in the stable efficiency group, such that the abnormal efficiency value will not be used for calculating the stable manufacturing efficiency value to raise the accuracy of the stable manufacturing efficiency value.

In some embodiments, the stable manufacturing efficiency generating system 100 further includes a stable efficiency predicting module 113. The stable efficiency predicting module 113 is coupled to the stable efficiency generating module 112 and the grouping parameter generating module 111. In some embodiments, the stable manufacturing efficiency generating system 100 further includes a real-time efficiency monitoring module 114. The real-time efficiency monitoring module 114 is coupled to the stable efficiency predicting module 113 and the stable efficiency generating module 112. In some embodiments, the stable manufacturing efficiency generating system 100 further includes a real-time data receiving module 115. The real-time data receiving module 115 is coupled to the real-time efficiency monitoring module 114 and the stable efficiency generating module 112. In some embodiments, the stable manufacturing efficiency generating system 100 further includes a database 120. The database 120 is, for example, a storing device or a cloud server. The database 120 is coupled to the grouping parameter generating module 111, the stable efficiency generating module 112, the stable efficiency predicting module 113 and the real-time data receiving module 115.

As used herein, “coupled” may refer to two or more elements are in “direct” physical or electrical contact made, or “indirectly”, as a mutual entity or electrical contact, and may also refer to two or more elements are operating or action.

As mentioned above, the grouping parameter generating module 111, the stable efficiency generating module 112, the stable efficiency predicting module 113, real-time efficiency monitoring module 114 and the real-time data receiving module 115 may be implemented in terms of software, hardware and/or firmware. For instance, if the execution speed and accuracy have priority, the above-mentioned modules may be implemented in terms of hardware and/or firmware. If the design flexibility has higher priority, then the above-mentioned modules may be implemented in terms of software. Furthermore, the above-mentioned modules may be implemented in terms of software, hardware and firmware in the same time. It is noted that the foregoing examples or alternates should be treated equally, and the present disclosure is not limited to these examples or alternates. Anyone who is skilled in the prior art can make modification to these examples or alternates in flexible way if necessary. In some embodiments, the grouping parameter generating module 111, the stable efficiency generating module 112, the stable efficiency predicting module 113, real-time efficiency monitoring module 114 and the real-time data receiving module 115 may be integrated into a processing device. The processing device includes a CPU, a control element, a micro processor unit or other hardware element being able to execute instructions. In other embodiments, the grouping parameter generating module 111, the stable efficiency generating module 112, the stable efficiency predicting module 113, real-time efficiency monitoring module 114 and the real-time data receiving module 115 may be implemented as a computer program and stored in a storing device. The storing device includes non-volatile computer-readable recording medium or other device with storing function. The computer program includes a plurality of program instructions. A CPU may execute the program instructions to perform functions of each module.

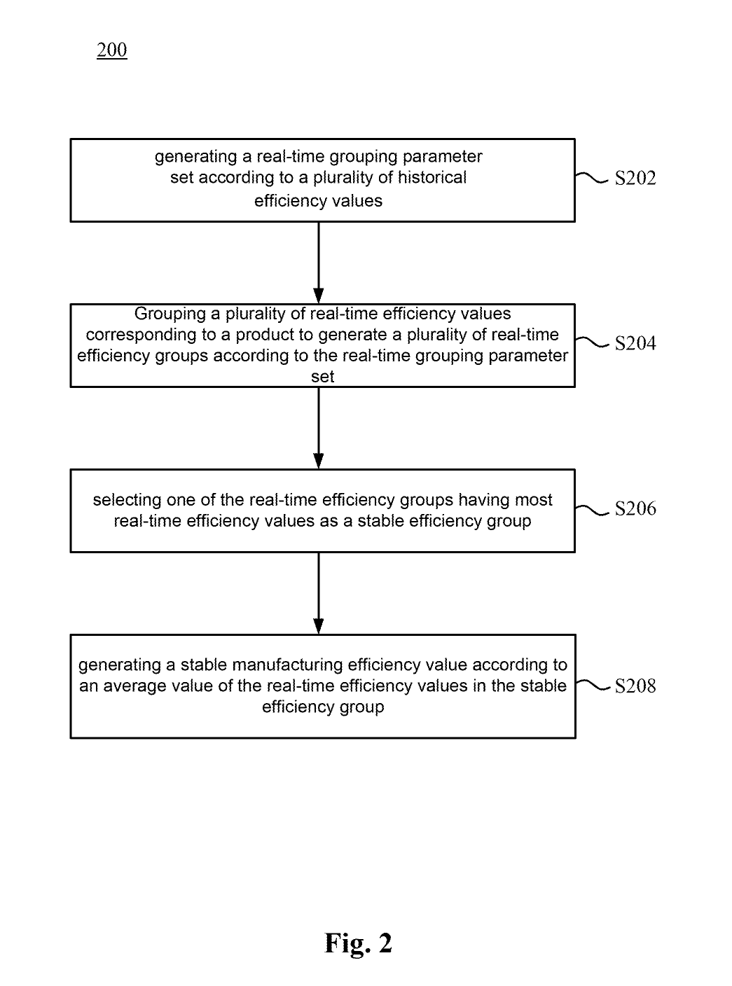

FIG. 2 is a flow diagram illustrating the stable manufacturing efficiency generating method 200 according to one embodiment of this disclosure. As illustrated in FIG. 2, the stable manufacturing efficiency generating method 200 includes step S202, step S204, step S206 and step S208. The stable manufacturing efficiency generating method 200 in FIG. 2 may be implemented to the stable manufacturing efficiency generating system 100 in FIG. 1.

As illustrated in FIG. 1 and FIG. 2, in step S202, the grouping parameter generating module 111 is configured to generate a real-time grouping parameter set X(Xm, Xb) according to a plurality of historical efficiency values H1-Hn. Xm represents a moving distance and Xb represents a grouping bandwidth. The historical efficiency values H1-Hn are stored in database 120. In some embodiments, the historical efficiency values H1-Hn are corresponding to a product. In some embodiments, parts of the historical efficiency values H1-Hn are corresponding to the product.

For a purpose of easily understanding, it is taken as an example that the historical efficiency values H1-Hn are corresponding to a product (product P). For instance, the product P has been manufactured three times during a past time period. The past time period is, for example, a season, a half-year, a year or a product generation, but is not limited thereto. The historical efficiency values H1-H5 are efficiency values obtained at five different times of a first manufacturing process. The historical efficiency values H6-H10 are efficiency values obtained at five different times of a second manufacturing process. The historical efficiency values H11-H15 are efficiency values obtained at five different times of a third manufacturing process. The grouping parameter generating module 111 groups the historical efficiency values H1-H5 according to a historical grouping parameter set (Xm1, Xb1). Xm1 represents a moving distance and Xb1 represents a grouping bandwidth.

The grouping parameter generating module 111 groups the historical efficiency values H1-H5 to generate a plurality of historical efficiency groups. It is assumed that the moving distance Xm1 is 0.1 and the grouping bandwidth Xb1 is 0.3. Thus, a range of a first historical efficiency group is from 0 to 0.3, a range of a second historical efficiency group is from 0.1 to 0.4, a range of a third historical efficiency group is from 0.2 to 0.5, and so on. It is assumed that the historical efficiency value H1 is 0.05, the historical efficiency value H2 is 0.35, the historical efficiency value H3 is 0.40, the historical efficiency value H4 is 0.45 and the historical efficiency value H5 is 0.50. At this time, the first historical efficiency group includes the historical efficiency value H1. The second historical efficiency group includes the historical efficiency values H2 and H3. The third historical efficiency group includes the historical efficiency values H2, H3, H4 and H5. In other words, the third historical efficiency group includes most historical efficiency values and the second historical efficiency group includes second most historical efficiency values. It is noted that, in some embodiments, two historical efficiency groups may be overlapped. That is, a historical efficiency value may be contained in two or more historical efficiency groups. In some other embodiments, two historical efficiency groups may not be overlapped. It is based on the design of the historical grouping parameter set that two historical efficiency groups are overlapped or not.

Moreover, in above example, an average value of the first historical efficiency group is 0.05, an average value of the second historical efficiency group is 0.375, and an average value of the third historical efficiency group is 0.425. In other words, the average value of the third historical efficiency group is largest and the average value of the second historical efficiency group is second largest. In a state where a historical efficiency group having most historical efficiency values is larger than an average value of another historical efficiency group having second most historical efficiency values, the historical grouping parameter set (Xm1, Xb1) is a quasi real-time grouping parameter set of the first manufacturing process of the product P.

Moreover, the grouping parameter generating module 111 further separately utilizes other historical grouping parameter sets (Xm2, Xb2)-(Xmn, Xbn) to group the historical efficiency values H1-H5. It is noted that it is possible that a plurality of historical grouping parameter sets are the quasi real-time grouping parameter set of the first manufacturing process of the product P.

Moreover, the grouping parameter generating module 111 also separately utilizes above-mentioned historical grouping parameter sets (Xm1, Xb1)-(Xmn, Xbn) to group the historical efficiency values H6-H10 to obtain one or more quasi real-time grouping parameter sets of the second manufacturing process of the product P. It is noted that it is possible that a plurality of historical grouping parameter sets are the quasi real-time grouping parameter set of the second manufacturing process of the product P. Moreover, the grouping parameter generating module 111 also separately utilizes above-mentioned historical grouping parameter sets (Xm1, Xb1)-(Xmn, Xbn) to group the historical efficiency values H11-H15 to obtain one or more quasi real-time grouping parameter set of the third manufacturing process of the product P. It is noted that it is possible that a plurality of historical grouping parameter sets are the quasi real-time grouping parameter set of the third manufacturing process of the product P.

If a probability of a historical grouping parameter set being the quasi real-time grouping parameter set is largest, the historical grouping parameter set will be selected as the real-time grouping parameter set. For instance, if the historical grouping parameter sets (Xm1, Xb1) is the quasi real-time grouping parameter set of the first manufacturing process of the product P and the historical grouping parameter sets (Xm1, Xb1) is also the quasi real-time grouping parameter set of the second manufacturing process of the product P, but other historical grouping parameter sets are only the quasi real-time grouping parameter set of the second manufacturing process of the product P, the historical grouping parameter sets (Xm1, Xb1) will be selected as the real-time grouping parameter set (Xm, Xb).

In some embodiments, the grouping parameter generating module 111 may re-decide the real-time grouping parameter set (Xm, Xb) after a predetermined time. The predetermined time is, for example, a season, a half-year, a year or a product generation, but is not limited thereto.

In step S204, after the real-time grouping parameter set (Xm, Xb) is determined, the stable efficiency generating module 112 groups a plurality of real-time efficiency values R1-Rn corresponding to a product according to the real-time grouping parameter set to generate a plurality of real-time efficiency group. It is noted that the product corresponding to the real-time efficiency values R1-Rn may be the product P or other product. In other words, in some embodiments, the real-time efficiency values R1-Rn may be manufacturing efficiency values of the product P obtained at n different times. In some other embodiments, the real-time efficiency values R1-Rn may be manufacturing efficiency values of the other product obtained at n different times.

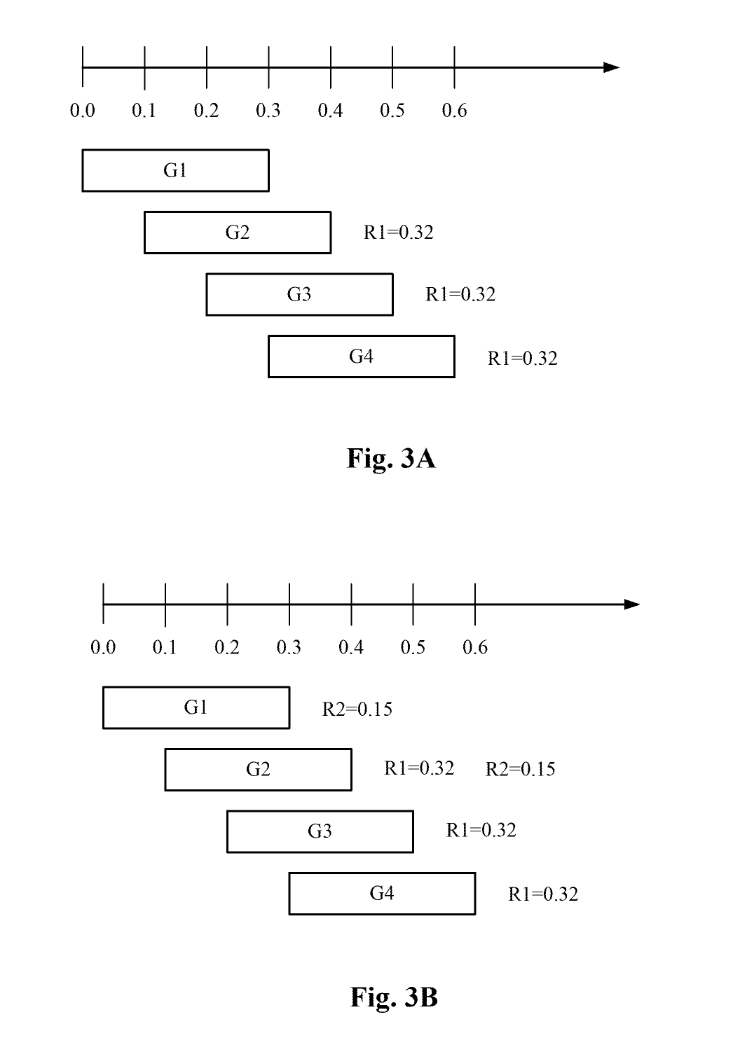

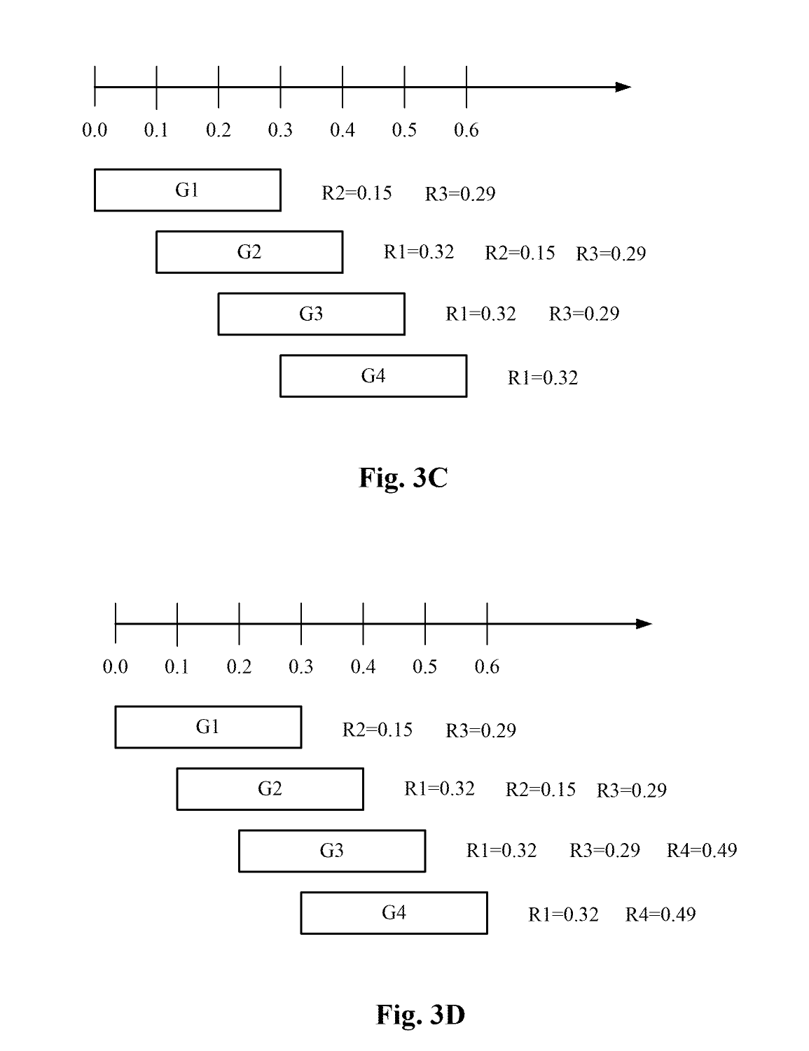

FIG. 3A-3D is a schematic diagram illustrating a calculation of a stable manufacturing efficiency value according to one embodiment of this disclosure. For instance, it is assumed that the moving distance Xm is 0.1 and the grouping bandwidth Xb is 0.3. A range of a real-time efficiency group G1 is from 0 to 0.3, a range of a real-time efficiency group G2 is from 0.1 to 0.4, a range of a real-time efficiency group G3 is from 0.2 to 0.5, a range of a real-time efficiency group G4 is from 0.3 to 0.6, and so on.

In step S206, the stable efficiency generating module 112 is configured to select one of the real-time efficiency groups having most real-time efficiency values as a stable efficiency group. In step S208, the stable efficiency generating module 112 is configured to generate a stable manufacturing efficiency value E according to an average value of the real-time efficiency values of the stable efficiency group.

For instance, as illustrated in FIG. 3A, a real-time efficiency value R1 received at a first time by the stable efficiency generating module 112 is 0.32. The stable efficiency generating module 112 determines that the real-time efficiency value R1 belongs to the real-time efficiency group G2, the real-time efficiency group G3 and the real-time efficiency group G4. At this time, the stable manufacturing efficiency value E is 0.32.

Then, as illustrated in FIG. 3B, a real-time efficiency value R2 received at a second time by the stable efficiency generating module 112 is 0.15. The stable efficiency generating module 112 determines that the real-time efficiency value R2 belongs to the real-time efficiency group G1 and the real-time efficiency group G2. At this time, since the real-time efficiency group G2 includes most real-time efficiency values, the stable efficiency generating module 112 selects the real-time efficiency group G2 as the stable efficiency group. At this time, an average value of the real-time efficiency values of the real-time efficiency group G2 is the stable manufacturing efficiency value E. In other words, the stable manufacturing efficiency value E changes to 0.235.

Then, as illustrated in FIG. 3C, a real-time efficiency value R3 received at a third time by the stable efficiency generating module 112 is 0.29. The stable efficiency generating module 112 determines that the real-time efficiency value R3 belongs to the real-time efficiency group G1, the real-time efficiency group G2, and the real-time efficiency group G3. In other words, the stable efficiency generating module 112 determines that the real-time efficiency value R3 belongs to the stable efficiency group (real-time efficiency group G2). At this time, since the real-time efficiency group G2 still includes most real-time efficiency values, the stable efficiency generating module 112 generates a new stable manufacturing efficiency value E′ according to the current stable manufacturing efficiency value E (0.235), number N (2) of old real-time efficiency values of the real-time efficiency group G2 and the new real-time efficiency value R (0.29), as a formula (1) shown below. Thus, the stable manufacturing efficiency value E is updated to be 0.253.

E′=(E×N+R)/(N+1) (1)

Thus, if a new real-time efficiency value is received, the stable efficiency generating module 112 does not calculate all real-time values to speed up the calculating speed.

Then, as illustrated in FIG. 3D, a real-time efficiency value R4 received at a fourth time by the stable efficiency generating module 112 is 0.49. The stable efficiency generating module 112 determines that the real-time efficiency value R4 belongs to the real-time efficiency group G3 and the real-time efficiency group G4. At this time, both of the real-time efficiency groups G2 and G3 include most real-time efficiency values. The stable efficiency generating module 112 utilizes the formula (1) shown above to calculate an average value of the real-time efficiency values in the real-time efficiency group G2 and an average value of the real-time efficiency values in the real-time efficiency group G3. The average value of the real-time efficiency group G2 is 0.253 and the average value of the real-time efficiency group G3 is 0.367. Then, the stable efficiency generating module 112 selects a real-time efficiency group whose average value is largest as the stable efficiency group. In other words, the stable efficiency generating module 112 selects the real-time efficiency group G3 as the stable efficiency group. At this time, the stable manufacturing efficiency value E is updated to be 0.367 according to the average value of the real-time efficiency group G3.

As illustrated in FIG. 1, the real-time data receiving module 115 is configured to receive the real-time efficiency values R1-Rn and at least one product feature A. For instance, the real-time efficiency values R1-Rn are corresponding to the manufacturing efficiencies of a product obtained at n different times, and the product feature A may be, for example, a specification, materials, manufacturers or manufacturing facilities of the product. The real-time efficiency values R1-Rn and the product feature A are stored in the database 120. If the real-time efficiency values R1-Rn are stored in the database 120 after a predetermined time, the real-time efficiency values R1-Rn turn into the historical efficiency values H1-Hn. The predetermined time is, for example, a season, a half-year, a year or a product generation, but is not limited thereto.

In some embodiments, the stable manufacturing efficiency E generated by stable efficiency generating module 112 is also transmitted to the database 120. The database 120 may be configured to store a corresponding relationship between the stable manufacturing efficiency value E and the product feature A. For instance, a product is corresponding to the product feature A, and the product is corresponding to the stable manufacturing efficiency value E. Thus, the stable manufacturing efficiency system 100 may determine which product is corresponding to a highest stable manufacturing efficiency value. If a manufacturer wants to manufacture a new product, a product feature (such as specification) of the product may be determined according to the data in the database 120 to raise the manufacturing efficiency of the new product.

Moreover, a plurality of stable manufacturing efficiency values E and a plurality of product features A corresponding to the stable manufacturing efficiency values E in the database 120 are transmitted to the stable efficiency predicting module 113. The stable efficiency predicting module 113 may establish a stable efficiency predicting model according to the stable manufacturing efficiency values E, the product features A and an instance-based learning method. In some embodiments, the stable efficiency predicting module 113 may utilize other model establishing methods to establish the stable efficiency predicting model. Thus, if a product feature A′ of a predicting product is received by the real-time data receiving module 115, the stable efficiency generating module 112 may be configured to determine whether the product feature A′ is the product feature A or not. If not, the product feature A′ is referred as a new product feature. Then, the stable efficiency generating module 112 may be configured to transmit the new product feature A′ to the stable efficiency predicting module 113. The stable efficiency predicting module 113 may generate a predicting stable efficiency value B according to the new product feature A′ and the stable efficiency predicting model. In some embodiments, the stable efficiency predicting module 113 may utilize, for example, a regression method, an interpolation method or other method to select a plurality of product features A which are similar with the new product feature A′ and to establish the stable efficiency predicting model according to the selected product features A and a plurality of stable manufacturing efficiency values E corresponding to the selected product features A. Thus, the stable efficiency predicting model is suitable for predicting the predicting stable efficiency value B of the predicting product. The manufacturer may figure out a manufacturing schedule of the predicting product according to the predicting stable efficiency value B. If the predicting stable efficiency value B is more accurate, the manufacturing schedule is also more accurate and the quoted price from the manufacturer is also more accurate. Thus, a probability of breach of contract may be reduced.

In some embodiments, if the stable efficiency generating module 112 determines that the product feature A′ is the new product feature, the stable efficiency generating module 112 may clean the values in the real-time efficiency groups G1-G4 in FIG. 3A and re-generate a real-time grouping parameter set.

In some embodiments, as illustrated in FIG. 1, the real-time efficiency monitoring module 114 determines whether an abnormal event occurs or not according to the real-time efficiency values R1-Rn from the real-time data receiving module 115, the stable manufacturing efficiency value E from the stable efficiency generating module 112 and the predicting stable efficiency value B from the stable efficiency predicting module 113. For instance, if a manufacturing facility is abnormal, the real-time efficiency values R1-Rn may be smaller than the stable manufacturing efficiency value E, and the real-time efficiency values R1-Rn may also be smaller than the predicting stable efficiency value B. At this time, the real-time efficiency monitoring module 114 may send out an alert signal to remind people to remove the abnormal event. Thus, the situation with low efficiency may be reduced and to raise the manufacturing efficiency of the product.

As the above embodiments, the stable manufacturing efficiency generating method and system of this disclosure group the plurality of real-time efficiency values according to the real-time grouping parameter set and only parts of real-time efficiency values are used for calculating the stable manufacturing efficiency value, time for calculation can be saved. Moreover, since the real-time grouping parameter set is generated according to the plurality of historical efficiency values, the real-time grouping parameter set extremely has reference value for grouping. Moreover, since the real-time efficiency group having most real-time efficiency values is selected as the stable efficiency group to calculate the stable manufacturing efficiency value, an abnormal efficiency value will not be contained in the stable efficiency group, such that the abnormal efficiency value will not be used for calculating the stable manufacturing efficiency value to raise the accuracy of the stable manufacturing efficiency value.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A stable manufacturing efficiency generating method comprising:
generating a real-time grouping parameter set according to a plurality of historical efficiency values;
grouping a plurality of real-time efficiency values corresponding to a product to generate a plurality of real-time efficiency groups according to the real-time grouping parameter set;
selecting one of the real-time efficiency groups having most real-time efficiency values as a stable efficiency group; and
generating a stable manufacturing efficiency value according to an average value of the real-time efficiency values in the stable efficiency group.

2. The stable manufacturing efficiency generating method of claim 1, wherein the step of generating the real-time grouping parameter set comprises:
grouping parts of the historical efficiency values according to one of historical grouping parameter sets to generate a plurality of historical efficiency groups,
wherein one of the historical grouping parameter sets is a quasi real-time grouping parameter set in a state where an average value of one of the historical efficiency groups having most historical efficiency values is larger than an average value of another one of the historical efficiency groups having second most historical efficiency values,
wherein the one of the historical grouping parameter sets is the real-time grouping parameter set in a state where a probability of the one of the historical grouping parameter sets being the quasi real-time grouping parameter set is larger than a probability of other historical grouping parameter sets being the quasi real-time grouping parameter set.

3. The stable manufacturing efficiency generating method of claim 1, wherein one of the real-time efficiency groups having most real-time efficiency values and having largest average value is selected to be as the stable efficiency group in a state where at least two of the real-time efficiency groups have most real-time efficiency values.

4. The stable manufacturing efficiency generating method of claim 1, further comprising:
determining whether a new real-time efficiency value belongs to the stable efficiency group or not in a state where the new real-time efficiency value is received; and
if yes, updating the stable manufacturing efficiency value according to the stable manufacturing efficiency value, number of the real-time efficiency values in the stable efficiency group and the new real-time efficiency value.

5. The stable manufacturing efficiency generating method of claim 1, further comprising:
establishing a stable efficiency predicting model according to a plurality of product features and a plurality of stable manufacturing efficiency values corresponding to the product features.

6. The stable manufacturing efficiency generating method of claim 5, further comprising:
generating a predicting stable efficiency value for a predicting product according to the stable efficiency predicting model.

7. The stable manufacturing efficiency generating method of claim 6, further comprising:
determining whether an abnormal event occurs or not according to at least one of the real-time efficiency values, the stable manufacturing efficiency value and the predicting stable efficiency value.

8. The stable manufacturing efficiency generating method of claim 6, wherein at least one of the real-time efficiency values is comprised in at least two of the real-time efficiency groups.

9. A stable manufacturing efficiency generating system comprising:
a grouping parameter generating module configured to generate a real-time grouping parameter set according to a plurality of historical efficiency values; and
a stable efficiency generating module configured to group a plurality of real-time efficiency values corresponding to a product to generate a plurality of real-time efficiency groups according to the real-time grouping parameter set, select one of the real-time efficiency groups having most real-time efficiency values as a stable efficiency group and generate a stable manufacturing efficiency value according to an average value of the real-time efficiency values in the stable efficiency group.

10. The stable manufacturing efficiency generating system of claim 9, wherein the grouping parameter generating module is configured to group parts of the historical efficiency values according to one of historical grouping parameter sets to generate a plurality of historical efficiency groups, wherein one of the historical grouping parameter sets is a quasi real-time grouping parameter set in a state where an average value of one of the historical efficiency groups having most historical efficiency values is larger than an average value of another one of the historical efficiency groups having second most historical efficiency values, wherein the one of the historical grouping parameter sets is the real-time grouping parameter set in a state where a probability of the one of the historical grouping parameter sets being the quasi real-time grouping parameter set is larger than a probability of other historical grouping parameter sets being the quasi real-time grouping parameter set.

11. The stable manufacturing efficiency generating system of claim 9, wherein the stable efficiency generating module is configured to select one of the real-time efficiency groups having most real-time efficiency values and having largest average value to be as the stable efficiency group in a state where at least two of the real-time efficiency groups have most real-time efficiency values.

12. The stable manufacturing efficiency generating system of claim 9, wherein the stable efficiency generating module is configured to determine whether a new real-time efficiency value belongs to the stable efficiency group or not in a state where the new real-time efficiency value is received, if yes, the stable efficiency generating module is configured to update the stable manufacturing efficiency value according to the stable manufacturing efficiency value, number of the real-time efficiency values in the stable efficiency group and the new real-time efficiency value.

13. The stable manufacturing efficiency generating system of claim 9, further comprising:
a stable efficiency predicting module configured to establish a stable efficiency predicting model according to a plurality of product features and a plurality of stable manufacturing efficiency values corresponding to the product features.

14. The stable manufacturing efficiency generating system of claim 13, wherein the stable efficiency predicting module is configured to generate a predicting stable efficiency value for a predicting product according to the stable efficiency predicting model.

15. The stable manufacturing efficiency generating system of claim 14, further comprising:
a real-time efficiency monitoring module configured to determine whether an abnormal event occurs or not according to at least one of the real-time efficiency values, the stable manufacturing efficiency value and the predicting stable efficiency value.

16. The stable manufacturing efficiency generating system of claim 15, wherein the real-time efficiency monitoring module is configured to send out an alert signal in a state where the abnormal event occurs.

17. The stable manufacturing efficiency generating system of claim 9, further comprising:
a real-time data receiving module configured to receive the plurality of real-time efficiency values and at least one product feature corresponding to the product.

18. The stable manufacturing efficiency generating system of claim 17, further comprising:
a database coupled to the real-time data receiving module and configured to store the plurality of historical efficiency values, the stable manufacturing efficiency value and the at least one product feature corresponding to the product.

19. The stable manufacturing efficiency generating system of claim 18, wherein the plurality of real-time efficiency values turn into the plurality of historical efficiency values in a state where the plurality of real-time efficiency values are stored in the database after a predetermined time.

20. A non-transitory computer readable storage medium storing a computer program, wherein the computer program is configured to execute a stable manufacturing efficiency generating method, and the stable manufacturing efficiency generating method comprises:
generating a real-time grouping parameter set according to a plurality of historical efficiency values;
grouping a plurality of real-time efficiency values corresponding to a product to generate a plurality of real-time efficiency groups according to the real-time grouping parameter set;
selecting one of the real-time efficiency groups having most real-time efficiency values as a stable efficiency group; and
generating a stable manufacturing efficiency value according to an average value of the real-time efficiency values in the stable efficiency group.
